(19) United States
(12) Patent Application Publication
(10) Pub. No.: US 2026/0220579 A1
(43) Pub. Date: Jul. 30, 2026

(54) INFORMATION PROCESSING APPARATUS, INFORMATION PROCESSING METHOD, AND NON-TRANSITORY COMPUTER-READABLE MEDIUM

(71) Applicant: NEC Corporation, Tokyo (JP)

(72) Inventors: Kei SATO, Tokyo (JP); Miku YANAGIMOTO, Tokyo (JP); Yukikazu YAMAOKA, Tokyo (JP)

(73) Assignee: NEC Corporation, Tokyo (JP)

(21) Appl. No.: 19/442,191

(22) Filed: Jan. 7, 2026

(30) Foreign Application Priority Data
Jan. 24, 2025 (JP) 2025-010258

(51) Int. Cl. G06Q 10/0635; G06Q 30/0201

(52) U.S. Cl. CPC G06Q 10/0635; G06Q 30/0206

(57) ABSTRACT

There are provided an information processing apparatus, an information processing method, and a program capable of easily grasping a risk associated with logistics work to be entrusted. The information processing apparatus according to the present disclosure includes a condition information acquisition unit that acquires entrustment condition information indicating a logistics entrustment condition, an environment information acquisition unit that acquires logistics environment information related to the logistics entrustment condition, an estimated risk acquisition unit that acquires estimated risk information indicating a risk of entrustment of logistics in accordance with the logistics entrustment condition, in which the risk is estimated based on at least one of the acquired entrustment condition information and the acquired logistics environment information, and a risk output unit that outputs the estimated risk information.

### INCORPORATION BY REFERENCE

This application is based upon and claims the benefit of priority from Japanese patent application No. 2025-010258, filed on January 24, 2025, the disclosure of which is incorporated herein in its entirety by reference.

### TECHNICAL FIELD

The present disclosure relates to an information processing apparatus, an information processing method, and a program.

### BACKGROUND ART

A technique for providing information with regard to logistics is known. For example, JP 2001-256586 A discloses an information service system that provides effective information for management or planning of logistics by managing a position of a vehicle, a traffic state, and the like.

### SUMMARY

In a case in which logistics work is entrusted to another company, the logistics work may be stopped for some reasons if a logistics entrustment condition is not appropriate. Therefore, it is preferable for a trustor (for example, a consignor) of the logistics work to grasp a risk associated with the logistics work to be entrusted to a contractor (for example, a logistics company). However, the technique disclosed in JP 2001-256586 A merely provides information for achieving efficient logistics, and the above-described risk cannot be grasped by the technique.

Therefore, an example object to be achieved by an example embodiment disclosed in this specification is to provide an information processing apparatus, an information processing method, and a program capable of easily grasping a risk associated with logistics work to be entrusted.

An information processing apparatus according to a first example aspect of the present disclosure includes

a condition information acquisition unit that acquires entrustment condition information indicating a logistics entrustment condition,

an environment information acquisition unit that acquires logistics environment information related to the logistics entrustment condition,

an estimated risk acquisition unit that acquires estimated risk information indicating a risk of entrustment of logistics in accordance with the logistics entrustment condition, in which the risk is estimated based on at least one of the acquired entrustment condition information and the acquired logistics environment information, and

a risk output unit that outputs the estimated risk information.

An information processing method according to a second example aspect of the present disclosure includes

acquiring entrustment condition information indicating a logistics entrustment condition,

acquiring logistics environment information related to the logistics entrustment condition,

acquiring estimated risk information indicating a risk of entrustment of the logistics in accordance with logistics entrustment condition, in which the risk is estimated based on at least one of the acquired entrustment condition information and the acquired logistics environment information, and

outputting the estimated risk information.

A program according to a third example aspect of the present disclosure causes a computer to execute

a condition information acquisition step of acquiring entrustment condition information indicating a logistics entrustment condition,

an environment information acquisition step of acquiring logistics environment information related to the logistics entrustment condition,

an estimated risk acquisition step of acquiring estimated risk information indicating a risk of entrustment of logistics in accordance with the logistics entrustment condition, in which the risk is estimated based on at least one of the acquired entrustment condition information and the acquired logistics environment information, and

a risk output step of outputting the estimated risk information.

An example of an effect of the present disclosure is to provide an information processing apparatus, an information processing method, and a program capable of easily grasping a risk associated with logistics work to be entrusted.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating an example of a configuration of an information processing apparatus according to the present disclosure;

FIG. 2 is a block diagram illustrating an example of the configuration of the information processing apparatus according to the present disclosure;

FIG. 3 is a schematic diagram illustrating an example of a screen displayed on a display by output processing of a risk output unit;

FIG. 4 is a flowchart illustrating an example of an operation of the information processing apparatus according to the present disclosure; and

FIG. 5 is a block diagram illustrating an example of a hardware configuration of a computer that implements a control unit of the information processing apparatus according to the present disclosure.

### EXAMPLE EMBODIMENTS

To clarify description, in the following description and drawings, omission and simplification are made as appropriate. In the drawings, the same or corresponding elements are denoted by the same reference numerals, and repeated description will be omitted as necessary for clarity of description. Each of the drawings is merely an example for description of one or more example embodiments. Each of the drawings is not associated with only one specific example embodiment, but may be associated with one or more other example embodiments. As those skilled in the art will appreciate, various features or steps described with reference to any one of the drawings may be combined with features or steps illustrated in one or more other drawings, for example, to create an example embodiment that is not explicitly illustrated nor described. All of the features or steps illustrated in any one of the drawings for describing illustrative example embodiments are not necessarily mandatory, and some features or steps may be omitted. The order of the steps described in any one of the drawings may be changed as appropriate.

### Outline of Example Embodiments

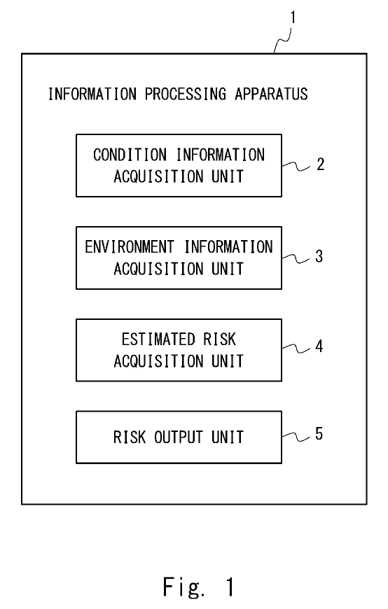

Hereinafter, a configuration example of an information processing apparatus 1 will be described with reference to FIG. 1. FIG. 1 is a block diagram illustrating an example of a configuration of the information processing apparatus 1. The information processing apparatus 1 includes a condition information acquisition unit 2, an environment information acquisition unit 3, an estimated risk acquisition unit 4, and a risk output unit 5. The information processing apparatus 1 is, for example, any apparatus including computer resources.

The condition information acquisition unit 2 acquires entrustment condition information indicating a logistics entrustment condition. Here, the logistics entrustment condition refers to any condition regarding logistics work to be entrusted to a contractor (for example, a logistics company) by a trustor (for example, a consignor). Here, the trustor may also be referred to as an orderer who orders logistics work in the contract to entrust the logistics work. The contractor may also be referred to as an order recipient who receives an order for the logistics work in the contract. Logistics work may include any work related to logistics. For example, the logistics work may include storage, loading and unloading, transportation, and the like of a cargo. Entrustment condition information acquired by the condition information acquisition unit 2 is, for example, information indicating a logistics entrustment condition for the logistics work already entrusted by the trustor, but may be information indicating a logistics entrustment condition for logistics work scheduled to be entrusted by the trustor.

The environment information acquisition unit 3 acquires logistics environment information related to the logistics entrustment condition indicated in the entrustment condition information acquired by the condition information acquisition unit 2. The logistics environment information is information to be referred to as necessary for evaluating the logistics entrustment condition, and is information indicating any environment of the logistics work. It can be said that the entrustment condition information is information changeable by the trustor, whereas the logistics environment information is information that cannot be changed by the trustor.

The estimated risk acquisition unit 4 acquires estimated risk information indicating a risk of entrusting logistics in accordance with the logistics entrustment condition, in which the risk is estimated based on at least one of the acquired entrustment condition information and the acquired logistics environment information. The estimated risk acquisition unit 4 may acquire the risk by the estimated risk acquisition unit 4 itself performing processing of estimating the risk. In addition, the estimated risk acquisition unit 4 may acquire the risk estimated by another device (for example, a server) by transmitting at least one of the entrustment condition information and the logistics environment information to the other device that performs processing of estimating the risk.

The risk output unit 5 outputs the estimated risk information acquired by the estimated risk acquisition unit 4. As processing of outputting the estimated risk information, the risk output unit 5 may perform, for example, processing of displaying the estimated risk information on any display or processing of transmitting the estimated risk information to another device.

According to the information processing apparatus 1, estimated risk information indicating a risk of entrusting logistics, which is estimated based on the entrustment condition information or the logistics environment information, is acquired, and the estimated risk information is output. For this reason, a trustor can easily grasp a risk associated with logistics work already entrusted by the trustor or logistics work scheduled to be entrusted by the trustor. Such an effect can also be obtained in an information processing method including the above-described processing of the information processing apparatus 1, a program for performing the above-described processing of the information processing apparatus 1, a non-transitory computer-readable medium storing the program therein, or the like.

Hereinafter, a more specific example embodiment will be described.

### Example Embodiment

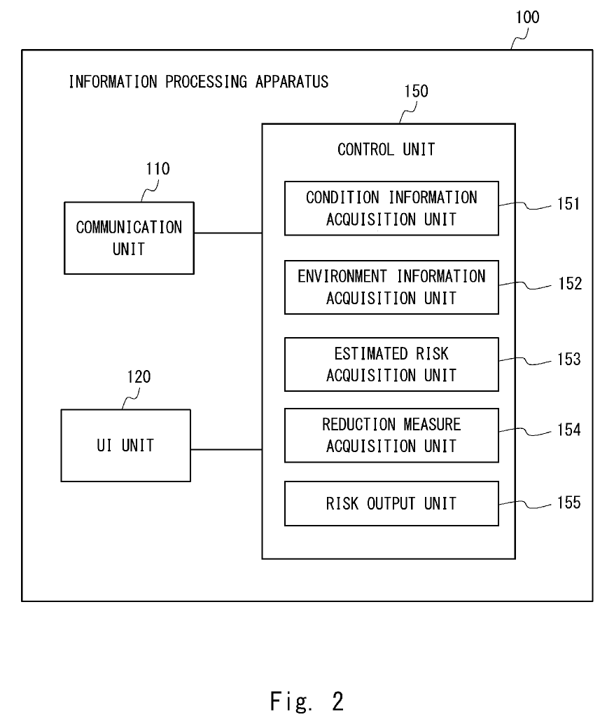

Hereinafter, a configuration example of an information processing apparatus 100 will be described with reference to FIG. 2. FIG. 2 is a block diagram illustrating an example of a configuration of the information processing apparatus 100. The information processing apparatus 100 only needs to be an apparatus including computer resources, and may be specifically a server (for example, a cloud server), a personal computer, a smartphone, a tablet terminal, or the like.

As illustrated in FIG. 2, the information processing apparatus 100 includes a communication unit 110, a UI unit 120, and a control unit 150.

The communication unit 110 is a hardware circuit that performs communication with another device according to a predetermined communication standard, and may include software such as firmware. Therefore, the information processing apparatus 100 may be communicably connected to a network such as the Internet. In this case, the information processing apparatus 100 can communicate with another device (for example, a server, a personal computer, a smartphone, or a tablet terminal) or the like connected to the network.

The UI unit 120 is a user interface device including an input device such as a keyboard or a pointing device that receives an input operation from a user, and a display. The UI unit 120 may be a touch panel in which the input device and the display are integrally configured. Furthermore, the UI unit 120 may include only one of the input device and the display. Furthermore, in a case in which the information processing apparatus 100 is a server or the like, the information processing apparatus 100 may not include the UI unit 120.

Next, the control unit 150 of the information processing apparatus 100 will be described. The control unit 150 executes control of the information processing apparatus 100 and any processing. In the present example embodiment, the control unit 150 includes a condition information acquisition unit 151, an environment information acquisition unit 152, an estimated risk acquisition unit 153, a reduction measure acquisition unit 154, and a risk output unit 155.

The condition information acquisition unit 151 corresponds to the condition information acquisition unit 2 described above. The condition information acquisition unit 151 acquires entrustment condition information indicating a logistics entrustment condition. The condition information acquisition unit 151 acquires, for example, the entrustment condition information input by a user to the information processing apparatus 100 via the UI unit 120, but may acquire the entrustment condition information without the operation of the user. For example, the condition information acquisition unit 151 may acquire the entrustment condition information by reading out the entrustment condition information stored in advance in a storage device or the like of the information processing apparatus 100, or may acquire the entrustment condition information by receiving the entrustment condition information from another device via the communication unit 110. In a case in which the condition information acquisition unit 151 receives the entrustment condition information from another device via the communication unit 110, the other device may be a user terminal communicably connected to the information processing apparatus 100. Here, the user terminal is a terminal device such as a personal computer, a smartphone, or a tablet terminal operated by the user.

In the present example embodiment, the logistics entrustment condition indicated by the entrustment condition information can include a work content of the logistics work, an entrustment fee, and the like. The information indicating the entrustment fee is also referred to as fee information. That is, the entrustment condition information may include fee information. In addition, identification information for identifying a contractor of the logistics work may be associated with the logistics entrustment condition. That is, the entrustment condition information may include identification information for identifying the contractor of the logistics work. For example, this identification information is information for identifying a logistics company to which logistics work is entrusted.

Here, an example of the work content of the logistics work indicating the logistics entrustment condition will be described. In a case in which the logistics work to be entrusted is cargo storage work, a work content indicated by the entrustment condition information may include, for example, a place where the storage work is performed, a schedule on which the storage work is performed, and the like. In addition, in a case in which the logistics work to be entrusted is cargo handling work, a work content indicated by the entrustment condition information may include, for example, a place where the cargo handling work is performed, equipment (for example, a forklift) used for the cargo handling work, a schedule on which the cargo handling work is performed, and the like. The place where the storage work or the cargo handling work is performed is not limited to a site (an address) where the work is performed, and may mean a type of structure of a building where the work is performed and a floor number of the floor on which the work is performed. In addition, in a case in which the logistics work to be entrusted is cargo transportation work, a work content indicated by the entrustment condition information includes the following. The work content indicated by the entrustment condition information may include, for example, a transportation type (land transportation, marine transportation, air transportation, and the like), a departure place and an arrival place of transportation, a transportation route, transportation equipment (trucks, motorbikes, container ships, ferries, cargo airplanes, passenger aircraft, and the like), a schedule on which transportation work is performed, a lead time indicating a transportation due date, a toll burden at the time of using an expressway, and an arrangement of necessary work manpower. In a case in which the lead time is extremely short, there is a possibility that the contractor of the logistics work may request cancellation of the contract. In addition, the toll burden at the time of using an expressway is an agreement on which one of the trustor and the contractor of the logistics work bears a road toll in a case in which a toll road such as an expressway is used in transportation such as emergency transportation or long-distance transportation. In addition, the arrangement of the necessary work manpower is an agreement on which one of the trustor and the contractor of the logistics work bears a fee for the manpower in a case in which additional work such as heavy goods transportation and unpacking and installation of goods is required, and an agreement on the fee to be borne.

The information indicating a site at which the logistics work is performed may be referred to as site information. In a case in which the logistics work to be entrusted is transportation work, a departure place of transportation, an arrival place of transportation, or a transportation route corresponds to the site information. In this manner, the entrustment condition information may include the site information. Further, information indicating the schedule on which the logistics work is performed may be referred to as schedule information. Accordingly, the entrustment condition information may include the schedule information.

Although a specific example of the entrustment condition information has been exemplified, the entrustment condition information may include other information. For example, the entrustment condition information may include manufacturing information indicating a construction time point of a building to be used for the logistics work or a manufacturing time point of a device to be used for the logistics work. Here, the equipment used in the logistics work is not limited to the equipment used in the transportation work, such as the transportation equipment, and includes any equipment used in the storage or cargo handling work. Further, the entrustment condition information may include standby time information indicating a standby time of a truck. The standby time of a truck refers to a time during which the truck needs to stand by at a predetermined place before the start of transportation or after the completion of transportation. Specifically, the standby time of a truck refers to, for example, a time during which the truck stands by until the order of the truck berth comes in a facility such as a logistics center, or a time during which the truck stands by until the cargo handling work ends in the facility. Further, the entrustment condition information may include working time information indicating the time of the cargo handling work.

The condition information acquisition unit 151 may acquire the entrustment condition information with regard to the logistics work already entrusted by the trustor, or may acquire the entrustment condition information with regard to the logistics work scheduled to be entrusted by the trustor. Further, the entrustment condition information is, for example, information based on an agreement (for example, a contract) between the trustor and the contractor of the logistics work, but is not limited thereto. In particular, as the entrustment condition information with regard to the logistics work already entrusted by the trustor, information based on performance of the logistics work actually performed by the contractor may be acquired.

In a case in which the same trustor has already performed a plurality of entrustments having different logistics entrustment conditions, or in a case in which the same trustor has planned a plurality of entrustments having different logistics entrustment conditions, the condition information acquisition unit 151 can acquire a plurality of pieces of entrustment condition information for the same trustor. In this manner, the condition information acquisition unit 151 may acquire a plurality of pieces of entrustment condition information having the same trustor.

The environment information acquisition unit 152 corresponds to the environment information acquisition unit 3 described above. The environment information acquisition unit 152 acquires logistics environment information. In particular, in the present example embodiment, the environment information acquisition unit 152 acquires logistics environment information related to the entrustment condition information acquired by the condition information acquisition unit 151. The environment information acquisition unit 152 may collect various kinds of logistics environment information in advance without determining the relevance to the entrustment condition information. In this case, after the condition information acquisition unit 151 acquires the entrustment condition information, the environment information acquisition unit 152 may extract the logistics environment information related to the entrustment condition information from the previously collected logistics environment information to acquire the logistics environment information related to the entrustment condition information.

The environment information acquisition unit 152 acquires logistics environment information that can be acquired from a predetermined communication network, such as logistics environment information disclosed on the Internet, using the communication unit 110. That is, the environment information acquisition unit 152 acquires, for example, the logistics environment information stored in a server that can provide the logistics environment information via the communication network. In the present example embodiment, as an example, the environment information acquisition unit 152 acquires the logistics environment information disclosed on a communication network such as the Internet, but the environment information acquisition unit 152 may acquire the logistics environment information by another method. For example, the environment information acquisition unit 152 may acquire the logistics environment information input by the user to the information processing apparatus 100 via the UI unit 120.

As described above, the logistics environment information is information indicating any environment of the logistics work for evaluating the logistics entrustment condition. Therefore, the logistics environment information can also be described as reference information to be referred to for evaluating the logistics entrustment condition. For example, the logistics environment information may be market price information indicating the market price of the entrustment fee for the logistics work. The market price is expressed as, for example, a unit price in accordance with a work content. In addition, the market price information may be, for example, information disclosed by an organization of a company belonging to the logistics industry, information disclosed by a predetermined administrative agency, or the like. In addition, the market price information may indicate a history of the market price from the past to the present. In this manner, the logistics environment information may include market price information. Therefore, for example, the environment information acquisition unit 152 acquires market price information corresponding to a work content indicated in the entrustment condition information acquired by the condition information acquisition unit 151.

Further, for example, the logistics environment information may be site feature information indicating a feature of a certain site (a region). The site feature information may indicate a feature related to traffic congestion, a feature related to weather, or a feature related to occurrence of a natural disaster. For example, the environment information acquisition unit 152 acquires site feature information indicating traffic congestion, weather, or natural disaster at a site indicated by the site information acquired as the entrustment condition information by the condition information acquisition unit 151. As described above, the logistics environment information may include the site feature information indicating traffic congestion, weather, or natural disaster at the site indicated by the site information. In particular, the environment information acquisition unit 152 acquires site feature information corresponding to a schedule indicated in the schedule information acquired as the entrustment condition information by the condition information acquisition unit 151. In this case, the environment information acquisition unit 152 may acquire the site feature information indicating record of traffic congestion, weather, or natural disaster in the same period in the past corresponding to the schedule indicated in the schedule information. Alternatively, the environment information acquisition unit 152 may acquire site feature information indicating a prediction of traffic congestion, weather, or a natural disaster of the schedule indicated in the schedule information.

For example, in a case in which the site feature information is information indicating a feature related to traffic congestion, the environment information acquisition unit 152 acquires information indicating congestion record or congestion prediction of traffic congestion corresponding to the schedule indicated by the schedule information, which is traffic congestion that occurs at a site indicated by the site information. Specifically, the environment information acquisition unit 152 acquires, for example, information indicating a degree of traffic congestion at a site (a road) through which transportation equipment passes in the transportation work as information indicating a feature related to traffic congestion. By acquiring such information, for example, it is possible to estimate the risk of hindering the implementation of the transportation work due to the occurrence of congestion.

Furthermore, in a case in which the site feature information is information indicating a feature related to weather, the environment information acquisition unit 152 acquires information indicating weather record or weather prediction corresponding to the schedule indicated in the schedule information, which is the weather at a site indicated by the site information. Specifically, the environment information acquisition unit 152 acquires, for example, information indicating a degree of bad weather or an occurrence rate of predetermined weather (bad weather) at a place where storage work or cargo handling work is performed or a site through which the transportation equipment passes in the transportation work as information indicating the features related to weather. Only one or both of the degree of bad weather and the occurrence rate may be acquired. Here, the weather may be, for example, a rainfall amount, a snowfall amount or a snow depth, or a temperature. These are merely examples of information indicating features related to the weather, and other information may be acquired. By acquiring such information, for example, it is possible to estimate a risk that the implementation of the storage work or the cargo handling work is hindered by bad weather.

In a case in which the site feature information is information indicating features related to a natural disaster, the environment information acquisition unit 152 acquires information indicating a disaster record or a disaster prediction corresponding to the schedule indicated in the schedule information, which is a natural disaster at a site indicated by the site information. Specifically, the environment information acquisition unit 152 acquires, for example, information indicating an occurrence rate of a natural disaster occurring at a place where storage work or cargo handling work is performed, or at a site through which transportation equipment passes in transportation work, or a scale of the natural disaster that has occurred, as information indicating the features related to the natural disaster. Only one or both of the occurrence rate and the scale of the natural disaster may be acquired. The natural disaster referred to herein may be, for example, a disaster caused by a typhoon (for example, flooding of rivers or landslides), a volcanic eruption, or an earthquake. These are merely examples of natural disasters, and information with regard to other natural disasters may be acquired. By acquiring such information, for example, it is possible to estimate a risk that the implementation of the logistics work is hindered by the natural disaster.

In addition, for example, the logistics environment information may be public announcement case information indicating a case of illegal entrustment which is publicly announced by a predetermined organization. That is, the logistics environment information may include public announcement case information. The public announcement case information includes, for example, information indicating a factor that is determined as illegal entrustment (for example, whether the factor is illegal entrustment due to too low entrustment fee or illegal entrustment due to too long standby time). In addition, the public announcement case information may include identification information for identifying a trustor or a contractor of logistics work that has been determined as illegal entrustment. The public announcement case information may include information indicating the number of occurrences of illegal entrustment for each factor determined as illegal entrustment. In the present example embodiment, the environment information acquisition unit 152 acquires public announcement case information published during a predetermined period (for example, the last month or the like). The environment information acquisition unit 152 may acquire public announcement case information including identification information (that is, identification information with regard to a contractor of logistics work) acquired as the entrustment condition information by the condition information acquisition unit 151.

In addition, for example, the logistics environment information may be evaluation information indicating evaluation of management of a contractor (an entrusted company). The evaluation information may be any information indicating any evaluation on the management of a company. For example, the evaluation information may be information for evaluating a financial condition of the company, or may be information for evaluating whether the company safely performs logistics work based on the record of accidents of logistics work, which are caused by the company (traffic accidents, fire accidents, and the like). For example, the environment information acquisition unit 152 acquires evaluation information of a company identified by identification information (that is, identification information with regard to a contractor of logistics work) acquired as the entrustment condition information by the condition information acquisition unit 151. As described above, the logistics environment information may include evaluation information with regard to a company identified by the identification information.

The above-described public announcement case information or evaluation information may be, for example, information provided (publicly announced) by a predetermined organization that supervises or evaluates logistics. Here, the predetermined organization may be an administrative agency that supervises any company that entrusts logistics work or is entrusted with logistics work, or may be a company that evaluates any company that entrusts logistics work or is entrusted with logistics work.

Although the specific example of the logistics environment information has been exemplified above, the logistics environment information may include information other than the above-described information. Further, in a case in which the environment information acquisition unit 152 acquires logistics environment information via the communication unit 110, the environment information acquisition unit 152 may acquire the logistics environment information directly from an information source (for example, an administrative agency or the like) of the logistics environment information, or may acquire the logistics environment information from a news site or a social networking service (SNS).

Next, the estimated risk acquisition unit 153 will be described. The estimated risk acquisition unit 153 corresponds to the estimated risk acquisition unit 4 described above. Therefore, the estimated risk acquisition unit 153 acquires the estimated risk information estimated based on at least one of the acquired entrustment condition information and the acquired logistics environment information. Here, the estimated risk information is information indicating a risk of entrustment of logistics in accordance with the logistics entrustment condition indicated by the entrustment condition information acquired by the condition information acquisition unit 151. This risk is estimated by performing predetermined estimation processing. That is, the estimated risk information is generated by performing predetermined estimation processing. In the present example embodiment, as an example, the estimated risk acquisition unit 153 itself executes the estimation processing. However, an external device communicably connected to the information processing apparatus 100 may perform the estimation processing, and the estimated risk acquisition unit 153 may acquire a result of the estimation processing from the external device. The external device may be a server such as a cloud server.

In the present example embodiment, in the estimation processing, a risk value is estimated for each of a plurality of types of risk factors. For example, in the estimation processing, a risk value indicating the magnitude of a risk having an entrustment fee as a risk factor is estimated based on the fee information acquired as the entrustment condition information and the market price information acquired as the logistics environment information. In this estimation processing, for example, a higher risk value is calculated as entrustment is performed at a lower fee than the market price indicated in the market price information corresponding to a work content. The reason for this is that, for example, in a case in which the entrustment fee is too low compared to a standard fee, there is a possibility that the contract may be offered to be terminated by a contractor, or the too low entrustment fee may infringe the laws such as the Unfair Competition Prevention Act. In addition, in this estimation processing, for example, a higher risk value may be calculated as entrustment is performed at a higher fee than the market price indicated in the market price information. The reason for this is that, for example, in a case in which the entrustment fee is too high, there is a possibility that the trustor cannot secure a sufficient profit. In this manner, the estimated risk acquisition unit 153 may acquire, for example, the estimated risk information indicating the risk estimated based on the fee information and the market price information. In order to estimate the risk value indicating the magnitude of the risk having an entrustment fee as a risk factor, information (entrustment condition information or logistics environment information) other than the fee information and the market price information may be further used. In addition, hereinafter, the risk having an entrustment fee as a risk factor is referred to as a “price risk”. By estimating the price risk, the user can grasp the risk from the viewpoint of the entrustment fee.

In addition, for example, in the estimation processing, a risk value indicating the magnitude of a risk having a feature (a feature of a region to which the site belongs regarding traffic congestion, weather, or natural disaster) of a region of the site as a risk factor is estimated based on the above-described site feature information acquired as the logistics environment information. In this estimation processing, for example, a higher risk value is calculated as the influence of the feature indicated by the acquired site feature information on the logistics work increases. For example, as a degree of congestion indicated by the site feature information is larger, a higher risk value is calculated. Furthermore, for example, a higher risk value is calculated as a degree of bad weather or an occurrence rate of predetermined weather indicated by the site feature information is higher. In addition, for example, as an occurrence rate of a natural disaster or a scale of a natural disaster indicated by the site feature information is larger, a higher risk value is calculated. In this manner, the estimated risk acquisition unit 153 may acquire, for example, the estimated risk information indicating the risk estimated based on the site feature information of the site indicated by the site information (that is, the entrustment condition information). In order to estimate the risk value indicating the magnitude of the risk having a feature of a region as a risk factor, information other than the site feature information (entrustment condition information or logistics environment information) may be further used. For example, information such as a type of the structure of a building where logistics work is performed or a floor number of the floor where logistics work is performed may be used, or information with regard to a transportation route or transportation equipment may be used to determine a degree of influence of congestion. In addition, hereinafter, the risk having a feature of a region as a risk factor is referred to as a “regional feature risk”. By estimating the site feature risk, the user can grasp the risk from the viewpoint of a feature of a region.

In addition, for example, in the estimation processing, a risk value indicating the magnitude of a risk having the evaluation of a contractor as a risk factor is estimated based on the above-described evaluation information acquired as the logistics environment information. In this estimation processing, for example, a higher risk value is calculated as the evaluation indicated by the acquired evaluation information is lower. In this manner, the estimated risk acquisition unit 153 may acquire, for example, estimated risk information indicating the risk estimated based on the evaluation information. In order to estimate the risk value indicating the magnitude of the risk having evaluation as a risk factor, information other than the evaluation information (entrustment condition information or logistics environment information) may be further used. In addition, hereinafter, the risk having evaluation of a contractor as a risk factor is referred to as a “contractor evaluation risk”. By estimating the contractor evaluation risk, the user can grasp the risk from the viewpoint of evaluation of the contractor.

As in each estimation processing described above, the risk value may be estimated based on the logistics environment information related to the acquired entrustment condition information. That is, the estimated risk acquisition unit 153 may acquire estimated risk information indicating the risk estimated based on the logistics environment information related to the entrustment condition information. As a result, it is possible to determine whether the entrustment condition is appropriate as compared with the logistics environment.

As described above, in the estimation processing, for example, the logistics environment information is used, but the logistics environment information may not necessarily be used in the estimation processing. Hereinafter, some examples of such estimation processing will be described.

For example, in the estimation processing, a risk value indicating the magnitude of a risk having deterioration of a building or a device as a risk factor may be estimated based on the above-described manufacturing information acquired as the entrustment condition information. In this estimation processing, for example, a higher risk value is calculated as a manufacturing time point of the building or the device indicated in the manufacturing information is older. As described above, the estimated risk acquisition unit 153 may acquire, for example, estimated risk information indicating the risk estimated based on the manufacturing information. In order to estimate the risk value indicating the magnitude of the risk having deterioration as a risk factor, information other than manufacturing information (entrustment condition information or logistics environment information) may be further used. Hereinafter, the risk having deterioration of a building or a device as a risk factor is referred to as a “deterioration risk”. By estimating the deterioration risk, the user can grasp the risk from the viewpoint of deterioration of the building or the device.

In addition, for example, in the estimation processing, a risk value indicating the magnitude of a risk having a degree of dispersion of an entrusted party as a risk factor may be estimated based on the above-described identification information of the contractor acquired as the entrustment condition information. In this estimation processing, for example, a higher risk value is calculated as the degree of dispersion of the entrusted party is lower. The degree of dispersion of the entrusted party can be specified based on the identification information with regard to a contractor of each entrustment included in a plurality of pieces of entrustment condition information in which the trustors are the same. In this manner, the estimated risk acquisition unit 153 may acquire, for example, estimated risk information indicating the risk estimated based on the degree of dispersion of the entrusted party. In order to estimate the risk value indicating the magnitude of the risk having a degree of dispersion of an entrusted party as a risk factor, information (entrustment condition information or logistics environment information) other than the identification information of the contractor may be further used. In addition, hereinafter, the risk having a degree of dispersion of an entrusted party as a risk factor is referred to as a “contractor concentration risk”. By estimating the contractor concentration risk, the user can grasp the risk from the viewpoint of dependence on a specific contractor.

In addition, for example, in the estimation processing, a risk value indicating the magnitude of a risk having a degree of dispersion of a site where logistics work is performed as a risk factor may be estimated based on the above-described site information acquired as the entrustment condition information. In this estimation processing, for example, a higher risk value is calculated as the degree of geographical dispersion of the site where the logistics work is performed is lower. In this manner, the estimated risk acquisition unit 153 may acquire, for example, estimated risk information indicating a risk estimated based on the degree of geographical dispersion of a site specified based on the site information. Note that, in order to estimate the risk value indicating the magnitude of the risk having a degree of dispersion of a site as a risk factor, information other than the site information (entrustment condition information or logistics environment information) may be further used. In addition, hereinafter, the risk having a degree of geographical dispersion of a site as a risk factor is referred to as “regional concentration risk”. By estimating the regional concentration risk, the user can grasp the risk from the viewpoint of dependence on a specific region.

In addition, for example, in the estimation processing, a risk value indicating the magnitude of a risk having a standby time as a risk factor may be estimated based on the above-described standby time information acquired as the entrustment condition information. The risk of having the standby time as a risk factor is a risk that occurs because the record of the standby time of a truck or the standby time of a truck, defined in the contract, is not an appropriate time length. That is, it can be said that this risk is a risk that it is determined by a contractor or the like that a trustor (consignor) entrusts inappropriate logistics work, or a delay occurs in logistics work. In this estimation processing, for example, in a case in which an actual value is acquired as the standby time information, a higher risk value is calculated as the actual value of the standby time is longer. The reason for this is that, in general, the length of the standby time does not affect the entrustment fee in many cases in the entrustment contract of the logistics work, and thus, the fact that the actual value of the standby time is long means that the logistics work to be entrusted becomes the logistics work having a poor profit rate from the viewpoint of a contractor. In addition, for example, in a case in which the standby time defined in the contract is acquired as the standby time information, a higher risk value is calculated as the standby time is shorter. The reason for this is that, in a case in which the standby time specified in the contract is too short, the logistics work may not be performed according to the schedule, and a delay may occur in the logistics work. Both the standby time on the contract and the actual standby time may be acquired as the entrustment condition information, and estimation processing may be performed based on a difference therebetween or the like. In this manner, the estimated risk acquisition unit 153 may acquire, for example, the estimated risk information indicating the risk estimated based on the standby time information. In order to estimate the risk value indicating the magnitude of the risk having a standby time as a risk factor, information other than the standby time information (entrustment condition information or logistics environment information) may be further used. In addition, hereinafter, the risk having a standby time as a risk factor is referred to as a “standby time risk”. By estimating the standby time risk, the user can grasp the risk from the viewpoint of the standby time.

Similarly to the standby time, for example, in the estimation processing, a risk value indicating the magnitude of a risk having a cargo handling working time as a risk factor may be estimated based on the above-described working time information acquired as the entrustment condition information. The risk of having a cargo handling working time as a risk factor is a risk that occurs because an actual cargo handling working time or a cargo handling working time specified in the contract is not an appropriate time length. That is, it can be said that this risk is a risk that it is determined by a contractor or the like that a trustor (consignor) entrusts inappropriate logistics work, or a delay occurs in logistics work. In this estimation processing, for example, in a case in which the actual value is acquired as the working time information, a higher risk value is calculated as the actual value of the working time is longer. The reason for this is that, in general, the length of the working time does not affect the entrustment fee in many cases in the entrustment contract of the logistics work, and thus, the fact that the actual value of the working time is long means that the logistics work to be entrusted becomes the logistics work having a poor profit rate from the viewpoint of the contractor. In addition, for example, in a case in which the working time defined in the contract is acquired as the working time information, a higher risk value is calculated as the working time is shorter. The reason for this is that, in a case in which the working time specified in the contract is too short, the logistics work may not be performed according to the schedule, and a delay may occur in the logistics work. Both the working time on the contract and the actual working time may be acquired as the entrustment condition information, and estimation processing may be performed based on a difference therebetween or the like. In this manner, the estimated risk acquisition unit 153 may acquire, for example, the estimated risk information indicating the risk estimated based on the working time information. In order to estimate the risk value indicating the magnitude of the risk having a cargo handling working time as a risk factor, information other than the working time information (entrustment condition information or logistics environment information) may be further used. In addition, hereinafter, the risk having a cargo handling working time as a risk factor is referred to as a “working time risk”. By estimating the working time risk, the user can grasp the risk from the viewpoint of the working time. The working time risk may include a risk in which it is determined that the contractor is or appears to be performing work that is out of the scope of the entrusted work, that is, work other than the work entrusted as a contract. For example, although only the transportation work is entrusted in the contract, non-contract cargo handling work such as labeling of a cargo and movement of a cargo in the base may occur. In such a case, if the working time is long, it may be determined that a contractor is performing or appears to be performing work that is out of the scope of the entrusted work.

In the present example embodiment, various risk values corresponding to the various risk factors described above are calculated in the estimation processing, but all the risk values described above may not necessarily be calculated in the estimation processing. That is, in the estimation processing, any one or more risk values among various risk values corresponding to various risk factors described above may be calculated. Furthermore, in the estimation processing, the risk value described above may be calculated according to a predetermined calculation algorithm (that is, a predetermined calculation rule), or the risk value may be calculated using a machine learning model (for example, a deep learning model or the like) learned in advance. This machine learning model may be, for example, a model learned in advance by using a pair of input data (input data to a model) including the logistics entrustment condition and the logistics environment information and a risk value which is a correct value of output data of the model as teacher data. Furthermore, the machine learning model may be a large language model (LLM), which is a machine learning model that provides a service of generative artificial intelligence (AI).

In a case in which various risk values corresponding to various risk factors are calculated, a total risk value, which is a total risk value of the risk factors, may be calculated in the estimation processing. In this case, in the estimation processing, the total risk value may be calculated based on the risk value calculated for each of the plurality of types of risk factors and a degree of importance of each of the risk factors. That is, the estimated risk information acquired by the estimated risk acquisition unit 153 may be information including the total risk value calculated based on the risk value calculated for each of the plurality of types of risk factors and the degree of importance of each of the risk factors. The importance of the risk factor can also be referred to as a degree of importance of the risk value corresponding to the risk factor. By acquiring the estimated risk information indicating the total risk value, the user can easily grasp the total risk based on various viewpoints.

The degree of importance for each risk factor may be set in advance, or may be settable by the user. For example, in a case in which a manager of a consignor is close to a manager of a specific logistics company, in a case in which the reliability of a specific logistics company is high, in a case in which a contract period with a specific logistics company is long, and the like, concentration of entrustment to the specific logistics company is not recognized as a risk for the consignor. In such a case, the user (consignor) may set a degree of importance of the contractor concentration risk to be lower than a predetermined set value. In addition, for example, in a case in which a range (a trading zone) in which a consignor conducts business activities is limited to a specific region, it is unavoidable that logistics work is conducted only in the region. Therefore, in such a case, the user (consignor) may set a degree of importance of the regional concentration risk to be lower than a predetermined set value. In this manner, the estimated risk acquisition unit 153 may acquire a total risk value calculated using a degree of importance set by the user. As a result, the user can grasp the risk appropriately evaluated depending on a situation of the user.

In addition, a value of the degree of importance for each risk factor used for calculating the total risk value may be set based on the public announcement case information related to the risk factor. In this case, for example, the estimated risk acquisition unit 153 sets the degree of importance of the risk factor related to the public announcement case information based on the public announcement case information acquired as the logistics environment information by the environment information acquisition unit 152. Specifically, for example, in a case in which the acquired public announcement case information is information to announce a case of illegal entrustment due to an excessively low entrustment fee, it can be considered that optimization of the entrustment fee is emphasized in the logistics industry. Therefore, in this case, the degree of importance of the risk factor corresponding to the entrustment fee may be changed to a value greater than a predetermined set value. In this manner, the total risk value may be calculated using a value set based on whether public announcement case information related to the risk factor has been acquired as a value of the degree of importance for each risk factor. As a result, the risk can be expected to be more appropriately evaluated.

The total risk value can be calculated, for example, from the degree of importance of each risk factor and the risk value in accordance with a predetermined calculation algorithm (that is, a predetermined calculation rule), but may be calculated using a machine learning model or the like learned in advance. Furthermore, the machine learning model may be a large language model (LLM) that provides a service of generative AI.

Next, the reduction measure acquisition unit 154 will be described. The reduction measure acquisition unit 154 acquires risk reduction information indicating a measure for reducing the estimated risk. In the present example embodiment, the reduction measure acquisition unit 154 acquires the risk reduction information using the large language model (LLM), which is a machine learning model that provides a service of generative AI. For example, the reduction measure acquisition unit 154 generates a prompt (a statement) including the information used in the estimation processing described above and an instruction sentence instructing output of a reduction measure of the risk estimated using the information, and inputs the prompt to the large language model (generative AI) learned in advance. Then, the reduction measure acquisition unit 154 acquires information output from the large language model (generative AI) as risk reduction information. As described above, the reduction measure acquisition unit 154 may acquire the risk reduction information from the large language model by inputting a statement generated based on the information used for risk estimation to the large language model. The processing using the large language model may be executed by the reduction measure acquisition unit 154 itself. That is, the information processing apparatus 100 may have a large language model. However, an external device (server) communicably connected to the information processing apparatus 100 may have a large language model, and the reduction measure acquisition unit 154 may acquire the output of the large language model from the external device. The external device may be a server such as a cloud server.

The risk output unit 155 performs processing of outputting information. As information output processing, the risk output unit 155 may perform, for example, processing of displaying the information on any display or processing of transmitting the information to another device. The risk output unit 155 corresponds to the risk output unit 5 described above. Therefore, the risk output unit 155 outputs the estimated risk information acquired by the estimated risk acquisition unit 153. The risk output unit 155 also outputs the risk reduction information acquired by the reduction measure acquisition unit 154. As a result, the user can easily know the measure for reducing the risk.

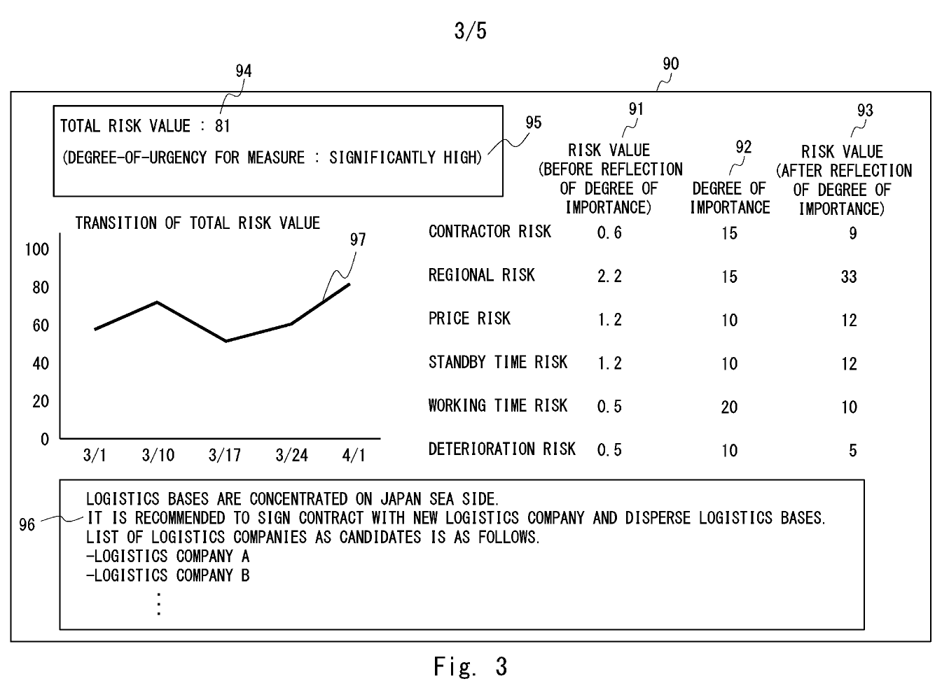

FIG. 3 is a schematic diagram illustrating an example of a screen displayed on a display such as the UI unit 120 by output processing of the risk output unit 155. In the example illustrated in FIG. 3, a screen 90 displays a risk value 91 estimated for each risk factor, a degree of importance 92 set for each risk factor, a risk value 93 corrected using the degree of importance 92, and a total risk value 94 calculated using the corrected risk value 93. In the example illustrated in FIG. 3, the risk value 93 obtained by multiplying the risk value 91 by the degree of importance 92 is illustrated, but the calculation example of the risk value 93 is not limited thereto. In addition, as illustrated in FIG. 3, the risk output unit 155 may output degree-of-urgency information 95 indicating a degree of urgency of implementing a measure for risk reduction. The degree-of-urgency information 95 is calculated from, for example, the total risk value 94. As illustrated in FIG. 3, the risk output unit 155 outputs risk reduction information 96 acquired by the reduction measure acquisition unit 154.

In FIG. 3, a “contractor risk” indicated as a risk factor means one or both of the “contractor concentration risk” and the “contractor evaluation risk” described above. Similarly, a “regional risk” indicated as a risk factor means one or both of the “regional concentration risk” and the “regional feature risk” described above.

In addition, the screen 90 includes information indicating transition of the risk. Specifically, the screen 90 includes a graph 97 showing the transition of the total risk value. That is, the risk output unit 155 may output the transition of the risk. As a result, the user can easily grasp the transition of the risk. The logistics environment is not constant and may vary from day to day. Therefore, the logistics environment information acquired by the environment information acquisition unit 152 may be different in a case in which an acquisition timing is different. In addition, a content of entrustment condition information may be different depending on an acquisition time in a case in which an entrustment condition is reviewed. Therefore, the estimated risk value may also vary depending on the estimation timing. For this reason, the risk output unit 155 may output a result of each estimation processing (for example, the graph 97) in a case in which the estimation processing is performed a plurality of times at intervals of time. Such processing of the risk output unit 155 can also be described as follows. That is, it can also be described that the risk output unit 155 compares and outputs a first risk and a second risk. Here, the first risk is a first risk (for example, a total risk value as of March 24) estimated based on entrustment condition information or logistics entrustment condition acquired at a first time point (for example, March 24). In addition, the second risk is a second risk (for example, a total risk value as of April 1) estimated based on entrustment condition information or logistics entrustment condition acquired at a second time point (for example, as of April 1) after the first time point.

The risk output unit 155 may not output all the information illustrated in FIG. 3 and may output only some arbitrary information.

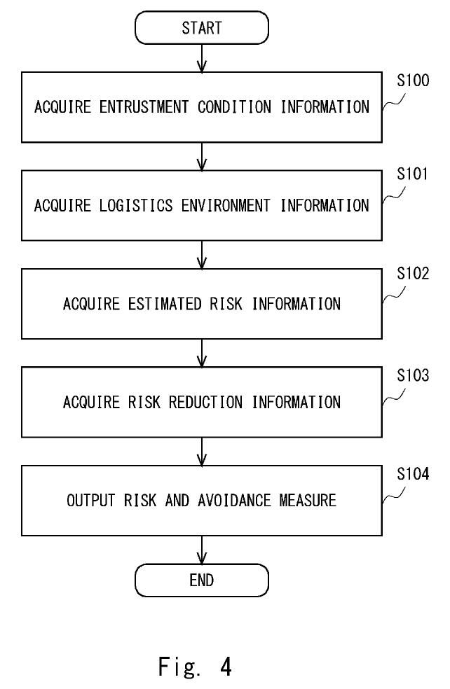

Next, an example of a flow of the above-described processing will be described with reference to a flowchart of FIG. 4. FIG. 4 is a flowchart illustrating an example of the operation of the information processing apparatus 100.

In step S100, the condition information acquisition unit 151 acquires entrustment condition information indicating a logistics entrustment condition. Next, in step S101, the environment information acquisition unit 152 acquires logistics environment information. Next, in step S102, the estimated risk acquisition unit 153 acquires estimated risk information using the information acquired in step S100 or step S101. Next, in step S103, the reduction measure acquisition unit 154 acquires risk reduction information. Finally, in step S104, the risk output unit 155 outputs the estimated risk information acquired in step S102 and the risk reduction information acquired in step S103.

The example embodiments have been described above. According to the example embodiment described above, estimated risk information indicating a risk of entrustment of logistics is acquired, and the estimated risk information is output. For this reason, a trustor can easily grasp a risk associated with logistics work already entrusted by the trustor or logistics work scheduled to be entrusted by the trustor. Therefore, the trustor can appropriately review an entrustment condition. This also contributes to suppressing unexpected stop of logistics work, occurrence of additional costs for responding to unexpected situations (such as emergency dispatch of personnel or vehicles), an increase in lead time, and the like.

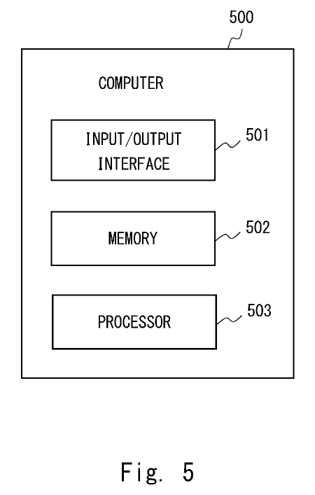

The information processing apparatus 100 described above may be implemented by a computer as illustrated in FIG. 5. FIG. 5 is a block diagram illustrating an example of a hardware configuration of the computer that implements the control unit 150. As illustrated in FIG. 5, a computer 500 includes an input/output interface 501, a memory 502, and a processor 503.

The input/output interface 501 is used to communicate with a configuration or the like other than the control unit 150 as necessary. The memory 502 is formed of, for example, a combination of a volatile memory and a nonvolatile memory. The memory 502 is used for storing software (a computer program) including one or more instructions to be executed by the processor 503, data used for various processes, and the like.

The processor 503 reads and executes the software (the computer program) from the memory 502 to perform processing of each component element of the control unit 150. The processor 503 may be, for example, a microprocessor, a micro processor unit (MPU), or a central processing unit (CPU). The processor 503 may include a plurality of processors.

The program includes instruction groups (or software codes) for causing the computer to perform one or more functions described in the example embodiment in a case of being read by the computer. The programs may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technique, a CD-ROM, a digital versatile disc (DVD), a Blu-ray (registered trademark) disc or any other optical disc storage, and a magnetic cassette, a magnetic tape, a magnetic disk storage, or any other magnetic storage device. The program may be transmitted through a transitory computer-readable medium or a communication medium. As an example and not by way of limitation, transitory computer-readable or communication media include electrical, optical, acoustic, or other forms of propagated signals.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

Some or all of the above example embodiments can also be described as the following Supplementary Notes, but are not limited to the following. Some or all the elements (for example, configurations and functions) described in Supplementary Notes 2 to 15 dependent on Supplementary Note 1 may also be dependent on Supplementary Notes 16 and 17 due to the same dependency relationship as Supplementary Notes 2 to 15. In addition, some or all of the elements described in any Supplementary Note may be applied to various types of hardware, software, recording means for recording software, systems, and methods.

### Supplementary Note 1

The information processing apparatus according to the present disclosure includes

a condition information acquisition means for acquiring entrustment condition information indicating a logistics entrustment condition,

an environment information acquisition means for acquiring logistics environment information related to the logistics entrustment condition,

an estimated risk acquisition means for acquiring estimated risk information indicating a risk of entrustment of logistics in accordance with the logistics entrustment condition, in which the risk is estimated based on at least one of the acquired entrustment condition information and the acquired logistics environment information, and

a risk output means for outputting the estimated risk information.

### Supplementary Note 2

The information processing apparatus according to supplementary note 1, in which the estimated risk acquisition means acquires the estimated risk information indicating the risk estimated based on at least the logistics environment information related to the entrustment condition information.

### Supplementary Note 3

The information processing apparatus according to supplementary note 1 or 2, in which

the entrustment condition information includes at least fee information indicating an entrustment fee,

the logistics environment information includes at least market price information indicating a market price of the entrustment fee, and

the estimated risk acquisition means acquires the estimated risk information indicating the risk estimated based on at least the fee information and the market price information.

### Supplementary Note 4

The information processing apparatus according to any one of supplementary notes 1 to 3, in which

the entrustment condition information includes at least site information indicating a site at which logistics work is performed,

the logistics environment information includes at least site feature information indicating traffic congestion, weather, or a natural disaster at the site indicated by the site information, and

the estimated risk acquisition means acquires the estimated risk information indicating the risk estimated based on at least the site feature information.

### Supplementary Note 5

The information processing apparatus according to any one of supplementary notes 1 to 4, in which

the entrustment condition information includes at least identification information for identifying a contractor of logistics work,

the logistics environment information includes at least evaluation information indicating evaluation of management of the contractor identified by the identification information, and

the estimated risk acquisition means acquires the estimated risk information indicating the risk estimated based on at least the evaluation information.

### Supplementary Note 6

The information processing apparatus according to any one of supplementary notes 1 to 5, in which the risk output means outputs transition of the risk.

### Supplementary Note 7

The information processing apparatus according to any one of supplementary notes 1 to 6, further including a reduction measure acquisition means for acquiring risk reduction information indicating a measure for reducing the risk from a large language model by inputting, to the large language model, a statement generated based on information used for estimation of the risk,

in which the risk output means further outputs the risk reduction information.

### Supplementary Note 8

The information processing apparatus according to any one of supplementary notes 1 to 7, in which the estimated risk information includes a total risk value calculated based on a risk value calculated for each of a plurality of types of risk factors and a degree of importance of each of the risk factors.

### Supplementary Note 9

The information processing apparatus according to supplementary note 8, in which the estimated risk acquisition means acquires the total risk value calculated using the degree of importance set by a user.

### Supplementary Note 10

The information processing apparatus according to supplementary note 8, in which

the logistics environment information includes public announcement case information indicating a case of illegal entrustment publicly announced by a predetermined organization, and

the estimated risk acquisition means acquires, as a value of the degree of importance for each risk factor used for calculation of the total risk value, the total risk value calculated using a value set based on the public announcement case information related to the risk factor.

### Supplementary Note 11

The information processing apparatus according to any one of supplementary notes 1 to 10, in which

the condition information acquisition means acquires a plurality of pieces of the entrustment condition information in which trustors are the same,

the entrustment condition information includes at least identification information for identifying a contractor of logistics work, and

the estimated risk acquisition means acquires the estimated risk information indicating the risk estimated based on a degree of dispersion of an entrusted party specified based on the identification information.

### Supplementary Note 12

The information processing apparatus according to any one of supplementary notes 1 to 11, in which

the entrustment condition information includes at least site information indicating a site at which logistics work is performed, and

the estimated risk acquisition means acquires the estimated risk information indicating the risk estimated based on a geographical dispersion degree of the site specified based on the site information.

### Supplementary Note 13

The information processing apparatus according to any one of supplementary notes 1 to 12, in which

the entrustment condition information includes at least standby time information indicating a standby time of a truck, and

the estimated risk acquisition means acquires the risk estimated based on at least the standby time information.

### Supplementary Note 14

The information processing apparatus according to any one of supplementary notes 1 to 13, in which

the entrustment condition information includes at least working time information indicating a time of cargo handling work, and

the estimated risk acquisition means acquires the estimated risk information indicating the risk estimated based on at least the working time information.

### Supplementary Note 15

The information processing apparatus according to any one of supplementary notes 1 to 14, in which

the entrustment condition information includes at least manufacturing information indicating a construction time point of a building used for logistics work or a manufacturing time point of a device used for the logistics work, and

the estimated risk acquisition means acquires the estimated risk information indicating the risk estimated based on at least the manufacturing information.

### Supplementary Note 16

An information processing method including

acquiring entrustment condition information indicating a logistics entrustment condition,

acquiring logistics environment information related to the logistics entrustment condition,

acquiring estimated risk information indicating a risk of entrustment of logistics in accordance with the logistics entrustment condition, in which the risk is estimated based on at least one of the acquired entrustment condition information and the acquired logistics environment information, and

outputting the estimated risk information.

### Supplementary Note 17

A non-transitory computer readable medium storing a program to cause a computer to execute

a condition information acquisition step of acquiring entrustment condition information indicating a logistics entrustment condition,

an environment information acquisition step of acquiring logistics environment information related to the logistics entrustment condition,

an estimated risk acquisition step of acquiring estimated risk information indicating a risk of entrustment of logistics in accordance with the logistics entrustment condition, in which the risk is estimated based on at least one of the acquired entrustment condition information and the acquired logistics environment information, and

a risk output step of outputting the estimated risk information.

What is claimed is:

1. An information processing apparatus comprising:
at least one memory storing instructions therein; and
at least one processor configured to execute the instructions to:
acquire entrustment condition information indicating a logistics entrustment condition;
acquire logistics environment information related to the logistics entrustment condition;
acquire estimated risk information indicating a risk of entrustment of logistics in accordance with the logistics entrustment condition, the risk being estimated based on at least one of the acquired entrustment condition information and the acquired logistics environment information; and
output the estimated risk information.

2. The information processing apparatus according to claim 1, wherein the processor is configured to execute the instruction to acquire the estimated risk information indicating the risk estimated based on at least the logistics environment information related to the entrustment condition information.

3. The information processing apparatus according to claim 1, wherein
the entrustment condition information includes at least fee information indicating an entrustment fee,
the logistics environment information includes at least market price information indicating a market price of the entrustment fee, and
the processor is configured to execute the instruction to acquire the estimated risk information indicating the risk estimated based on at least the fee information and the market price information.

4. The information processing apparatus according to claim 1, wherein
the entrustment condition information includes at least site information indicating a site at which logistics work is performed,
the logistics environment information includes at least site feature information indicating traffic congestion, weather, or a natural disaster at the site indicated by the site information, and
the processor is configured to execute the instruction to acquire the estimated risk information indicating the risk estimated based on at least the site feature information.

5. The information processing apparatus according to claim 1, wherein
the entrustment condition information includes at least identification information for identifying a contractor of logistics work,
the logistics environment information includes at least evaluation information indicating evaluation of management of the contractor identified by the identification information, and
the processor is configured to execute the instruction to acquire the estimated risk information indicating the risk estimated based on at least the evaluation information.

6. The information processing apparatus according to claim 1, wherein the processor is configured to execute the instruction to output transition of the risk.

7. The information processing apparatus according to claim 1, wherein the processor is configured to execute the instructions to:
acquire risk reduction information indicating a measure for reducing the risk from a large language model by inputting, to the large language model, a statement generated based on information used for estimation of the risk, and
output the risk reduction information.

8. The information processing apparatus according to claim 1, wherein the estimated risk information includes a total risk value calculated based on a risk value calculated for each of a plurality of types of risk factors and a degree of importance of each of the risk factors.

9. The information processing apparatus according to claim 8, wherein the processor is configured to execute the instruction to acquire the total risk value calculated using the degree of importance set by a user.

10. The information processing apparatus according to claim 8, wherein
the logistics environment information includes public announcement case information indicating a case of illegal entrustment publicly announced by a predetermined organization, and
the processor is configured to execute the instruction to acquire, as a value of the degree of importance for each risk factor used for calculation of the total risk value, the total risk value calculated using a value set based on the public announcement case information related to the risk factor.

11. The information processing apparatus according to claim 1, wherein
the processor is configured to execute the instruction to acquire a plurality of pieces of the entrustment condition information in which trustors are the same,
the entrustment condition information includes at least identification information for identifying a contractor of logistics work, and
the processor is configured to execute the instruction to acquire the estimated risk information indicating the risk estimated based on a degree of dispersion of an entrusted party specified based on the identification information.

12. The information processing apparatus according to claim 1, wherein
the entrustment condition information includes at least site information indicating a site at which logistics work is performed, and
the processor is configured to execute the instruction to acquire the estimated risk information indicating the risk estimated based on a geographical dispersion degree of the site specified based on the site information.

13. The information processing apparatus according to claim 1, wherein
the entrustment condition information includes at least standby time information indicating a standby time of a truck, and
the processor is configured to execute the instruction to acquire the risk estimated based on at least the standby time information.

14. The information processing apparatus according to claim 1, wherein
the entrustment condition information includes at least working time information indicating a time of cargo handling work, and
the processor is configured to execute the instruction to acquire the estimated risk information indicating the risk estimated based on at least the working time information.

15. The information processing apparatus according to claim 1, wherein
the entrustment condition information includes at least manufacturing information indicating a construction time point of a building used for logistics work or a manufacturing time point of a device used for the logistics work, and
the processor is configured to execute the instruction to acquire the estimated risk information indicating the risk estimated based on at least the manufacturing information.

16. An information processing method comprising:
acquiring entrustment condition information indicating a logistics entrustment condition;
acquiring logistics environment information related to the logistics entrustment condition;
acquiring estimated risk information indicating a risk of entrustment of logistics in accordance with the logistics entrustment condition, the risk being estimated based on at least one of the acquired entrustment condition information and the acquired logistics environment information; and
outputting the estimated risk information.

17. A non-transitory computer readable medium storing a program to cause a computer to execute:
a condition information acquisition step of acquiring entrustment condition information indicating a logistics entrustment condition;
an environment information acquisition step of acquiring logistics environment information related to the logistics entrustment condition;
an estimated risk acquisition step of acquiring estimated risk information indicating a risk of entrustment of logistics in accordance with the logistics entrustment condition, the risk being estimated based on at least one of the acquired entrustment condition information and the acquired logistics environment information; and
a risk output step of outputting the estimated risk information.
